(19) United States
(12) Patent Application Publication
(10) Pub. No.: US 2002/0051581 A1
(43) Pub. Date: May 2, 2002

(54) Video signal encoder and video signal decoder

(76) Inventors: Seiichi Takeuchi, Neyagawa (JP); Masakazu Nishino, Kashiwara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/881,688

(22) Filed: Jun. 18, 2001

(30) Foreign Application Priority Data
Jun. 19, 2000 (JP) 2000-183437

(51) Int. Cl. H04B 1/66; H04N 11/04

(52) U.S. Cl. 382/240; 375/240.02

(57) ABSTRACT

A video signal encoder 1 subjects an video signal 100 of high sampling rate to hierarchical encoding. An enhancement layer bitstream 105 is then recorded on a removable recording medium 51, while a base layer bitstream 102 in a storage 40. Prior to the base layer bitstream 102 being transmitted, the recording medium 51 is mounted to a video signal decoder 2 after billing management, for example. The video signal decoder 2 reproduces an enhancement layer bitstream 107 from the recording medium 51 in synchronization with the reception of the base layer bitstream 106. Then, the two bitstreams are subjected to hierarchical decoding, and the resulting decoded video signal 110 of high sampling rate is outputted. Without the recording medium 51 mounted, a decoded video signal 108 of low sampling rate is an only output. In this manner, the hierarchically-encoded video signal can be processed on a layer basis for billing and access management.

### BACKGROUND OF THE INVENTION

1. Field of the Invention

The present invention relates to a video signal encoder for subjecting a video signal to hierarchical encoding and transmitting the video signal, and a video signal decoder for receiving and decoding the video signal.

2. Description of the Background Art

A conventionally-known scheme is hierarchical encoding for transmission and reception of video signals. Under this scheme, one or more video signals of low resolution are hierarchically generated based on an original, and then those hierarchically-arranged video signals are encoded. In such hierarchical encoding, encoding is performed in consideration of characteristics similar among the video signals arranged in different layers. Specifically, before encoding the video signal in a certain layer, another video signal in the layer one level lower is referred to see how it has been encoded and decoded. In this manner, the resulting bitstream is reduced in data amount.

FIG. 4 is a block diagram showing the structure of a conventional system for transmitting and receiving video signals under such hierarchical encoding scheme. The system of FIG. 4 includes a video signal encoder 7 and a video signal decoder 8.

The video signal encoder 7 is provided with a down converter 10, a lower-layer encoder 11, an up converter 12, an upper-layer encoder 13, a transmitter 14, and a multiplexer 15. Herein, an input video signal 100 of high sampling rate (HSR video signal 100) is subjected to hierarchical encoding by the down converter 10, the lower-layer encoder 11, the up converter 12, and the upper-layer encoder 13. For example, with MPEG-2 encoding performed in a spatial scalability mode, the lower-layer encoder 11 outputs a base layer bitstream 102, and the upper-layer encoder 13 an enhancement layer bitstream 105.

The base layer bitstream 102 and the enhancement layer bitstream 105 are subjected to time division multiplexing by the multiplexer 15, and become a single multiplexed bitstream 120. The multiplexed bitstream 120 is then transmitted to the video signal decoder 8 by the transmitter 14.

The video signal decoder 8 includes a receiver 20, a lower-layer decoder 21, an up converter 22, an upper-layer decoder 23, and a demultiplexer 24. In the video signal decoder 8, the multiplexed bitstream 120 transferred from the video signal encoder 7 is first received by the receiver 20, and then outputted as a multiplexed bitstream 121. The multiplexed bitstream 121 is then subjected to time division demultiplexing by the demultiplexer 24, and separated into a base layer bitstream 106 and an enhancement layer bitstream 107. Those bitstreams 106 and 107 are decoded by the lower-layer decoder 21, the up converter 22, and the upper-layer decoder 23. Here, the decoding is carried out in an inverse manner to the encoding performed in the video signal encoder 7. After such decoding, derived are a decoded video signal 108 of low sampling rate (decoded LSR video signal 108) and a decoded video signal 110 of high sampling rate (decoded HSR signal 110).

Here, some type of video signal decoder 8 carries neither the up converter 22 nor the upper-layer decoder 23. If this is the case, the decoded LSR video signal 108 is only an output from the decoder 8 in such simplified structure.

As such, in the above conventional system under the hierarchical encoding scheme, a bitstream in an upper layer and another in a lower layer are multiplexed in the video signal encoder to be a single multiplexed bitstream. The resulting multiplexed bitstream is received and decoded by the video signal decoder within its capability.

The conventional system, however, bears such problem that bitstreams in various layers have to be transmitted/received under the same transmission/reception scheme. This is because the bitstreams are all multiplexed, regardless of which layer, to be a single bitstream for transmission and reception. As a result, in the conventional system, it is difficult to provide the bitstreams with each different worth, and to perform billing process and access management on a layer basis.

### SUMMARY OF THE INVENTION

Therefore, an object of the present invention is to provide a video signal encoder and a video signal decoder enabling the billing process and access management on a layer basis by transmitting and receiving bitstreams in different schemes depending on which layer.

The present invention has the following features to attain the object above.

A first aspect of the present invention is directed to a video signal encoder for encoding and transmitting a video signal, comprising: a hierarchical encoding unit for generating a second video signal of relatively lower-resolution from an inputted first video signal of relatively higher-resolution, deriving a lower-layer bitstream by encoding the second video signal, and deriving an upper-layer bitstream by encoding the first video signal utilizing a decoding result of the lower-layer bitstream; a transmission unit for transmitting the lower-layer bitstream; and a bitstream output unit for outputting the upper-layer bitstream separately from the transmission unit.

According to the first aspect, the upper-layer bitstream after hierarchical encoding is outputted from the bitstream output unit separately from the lower-layer bitstream. Therefore, with the billing and access management in the course of providing thus outputted upper-layer bitstream, the resulting video signal provided by the video signal decoder can be accordingly charged and accessed depending on its image quality.

In the first aspect above, the bitstream output unit may record the upper-layer bitstream on a removable recording medium. Accordingly, with the billing and access management on the recording medium in the course of distribution, the resulting video signal provided by the video signal decoder can be accordingly charged and accessed depending on its image quality.

Also in the first aspect, the bitstream output unit may transmit the upper-layer bitstream by communications means separately from the transmission unit. Accordingly, with the billing and access management in the course of transmitting and receiving the upper-layer bitstream, the resulting video signal provided by the video signal decoder can be accordingly charged and accessed depending on its image quality.

In this case, the bitstream output unit may store the upper-layer bitstream, and then transmits the upper-layer bitstream according to an inputted transmission request. By storing the upper-layer bitstream as such, the video signal decoder can transmit the upper-layer bitstream responding to the transmission request coming from the video signal decoder with an arbitrary timing. Alternatively, the bitstream output unit may go through the billing process according to the transmission request. Thus, with the billing process carried out in the video signal encoder, the resulting video signal provided by the video signal decoder can be accordingly charged and accessed depending on its image quality.

Further, the transmission unit may store the lower-layer bitstream, and transmits the bitstream after a predetermined lapse of time. By storing the lower-layer bitstream as such, the upper-layer bitstream can go to the video signal decoder first, and then the lower-layer bitstream follow.

Still further, in the first aspect, the hierarchical encoding unit may include a first format conversion unit for converting the first video signal in resolution to derive the second video signal; a lower layer encoding unit for deriving the lower-layer bitstream and the decoding result of the lower-layer bitstream by encoding the second video signal; a second format conversion unit for converting the decoding result into a video signal in the same format as the first video signal; and an upper layer encoding unit for deriving the upper-layer bitstream by encoding the first video signal utilizing the video signal derived by the second format conversion unit. With this structure, the hierarchical encoding can carried out in two levels, which is a typical manner, and consequently leading to the MPEG-2 hierarchical encoding.

A second aspect of the present invention is directed to a video signal decoder for receiving and decoding an encoded video signal. The video signal decoder comprises a reception unit for receiving a lower-layer bitstream among other bitstreams derived by hierarchically-encoding the video signal; a bitstream supply unit for supplying an upper-layer bitstream among the other bitstreams separately from the reception unit; and a hierarchical decoding unit for deriving a first video signal of relatively lower-resolution by decoding the lower-layer bitstream received by the reception unit, and deriving a second video signal of relatively higher-resolution by decoding the upper-layer bitstream utilizing the first video signal.

According to the second aspect, the upper-layer bitstream after hierarchical encoding is supplied from the bitstream supply unit separately from the lower-layer bitstream. Therefore, with the billing and access management in the course of receiving the upper-layer bitstream, the resulting video signal provided by the video signal decoder can be accordingly charged and accessed depending on its image quality.

In the second aspect above, the reception unit and the bitstream supply unit may supply the lower-and upper-layer bitstreams to the hierarchical decoding unit with synchronization established therebetween. By establishing synchronization as such prior to making a supply to the hierarchical decoding unit, the video signal can be correctly decoded.

Also in the second aspect, the bitstream supply unit may reproduce the upper-layer bitstream from a removable recording medium for supply to the hierarchical decoding unit. Accordingly, with the billing and access management on the recording medium in the course of distribution, the resulting video signal provided by the video signal decoder can be accordingly charged and accessed depending on its image quality.

Further, the bitstream supply unit may receive the upper-layer bitstream by communications means separately from the reception unit, and then store the received upper-layer bitstream first and then supply it to the hierarchical decoding unit. Accordingly, with the billing and access management in the course of transmitting and receiving the upper-layer bitstream, the resulting video signal provided by the video signal decoder can be accordingly charged and accessed depending on its image quality.

In this case, the bitstream supply unit may output a request to transmit the upper-layer bitstream responding to an inputted transmission request. Accordingly, responding to the user's transmission instruction coming with an arbitrary timing, the video signal encoder is requested to transmit the upper-layer bitstream.

In the second aspect, the reception unit may store the lower-layer bitstreams first, and then supply it to the hierarchical decoding unit. By storing the lower-layer bitstream as such, the video signal can be correctly decoded even if the lower-layer bitstream is received prior to the upper-layer bitstream.

Further, in the second aspect, the hierarchical encoding unit may include a lower-layer decoding unit for deriving the first video signal by decoding the lower-layer bitstream; a format conversion unit for converting the first video signal into a video signal in the same format as the second video signal; and an upper-layer decoding unit for deriving the second video signal by decoding the upper-layer bitstream utilizing the video signal derived by the format conversion unit. With this structure, the hierarchical decoding can carried out in two levels, which is a typical manner, and consequently leading to the MPEG-2 hierarchical decoding.

A third aspect of the present invention is directed to a video signal encoding method for encoding and transmitting a video signal, comprising the steps of: generating a second video signal of relatively lower-resolution from an inputted first video signal of relatively higher-resolution, deriving a lower-layer bitstream by encoding the second video signal, and deriving an upper-layer bitstream by encoding the first video signal utilizing a decoding result of the lower-layer bitstream; transmitting the lower-layer bitstream; and outputting the upper-layer bitstream separately from the transmitting step.

A fourth aspect of the present invention is directed to a video signal decoding method for receiving and decoding an encoded video signal, comprising the steps of: receiving a lower-layer bitstream among other bitstreams derived by hierarchically-encoding the video signal; supplying an upper-layer bitstream among the other bitstreams separately from the receiving step; and deriving a first video signal of relatively lower-resolution by decoding the lower-layer bitstream received in the receiving step, and deriving a second video signal of relatively higher-resolution by decoding the upper-layer bitstream supplied in the supplying step utilizing the first video signal.

A fifth aspect of the present invention is directed to a computer-readable recording medium on which a program to be run on a computer is recorded for executing a video signal encoding method for encoding and transmitting a video signal, the program comprising the steps of: generating a second video signal of relatively lower-resolution from an inputted first video signal of relatively higher-resolution, deriving a lower-layer bitstream by encoding the second video signal, and deriving an upper-layer bitstream by encoding the first video signal utilizing a decoding result of the lower-layer bitstream; transmitting the lower-layer bitstream; and outputting the upper-layer bitstream separately from the transmitting step.

A sixth aspect of the present invention is directed to a computer-readable recording medium on which a program to be run on a computer is recorded for executing a video signal decoding method for receiving and decoding an encoded video signal, the program comprising the steps of: receiving a lower-layer bitstream among other bitstreams derived by hierarchically-encoding the video signal; supplying an upper-layer bitstream among the other bitstreams separately from the receiving step; and deriving a first video signal of relatively lower-resolution by decoding the lower-layer bitstream received in the receiving step, and deriving a second video signal of relatively higher-resolution by decoding the upper-layer bitstream supplied in the supplying step utilizing the first video signal.

According to the third to sixth aspects, the upper-layer bitstream after hierarchical encoding is provided separately from the lower-layer bitstream. Accordingly, with the billing and access management in the course of transmitting the upper-layer bitstream, the resulting video signal provided by the video signal decoder can be accordingly charged and accessed depending on its image quality.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a video signal transmission/reception system according to a first embodiment of the present invention;

FIG. 2 is a block diagram showing the structure of a video signal transmission/reception system according to a second embodiment;

FIG. 3 is a block diagram showing the structure of a video signal transmission/reception system according to a third embodiment; and

FIG. 4 is a block diagram showing the structure of a conventional video signal transmission/reception system.

### DESCRIPTION OF THE PREFERRED EMBODIMENTS

(First Embodiment)

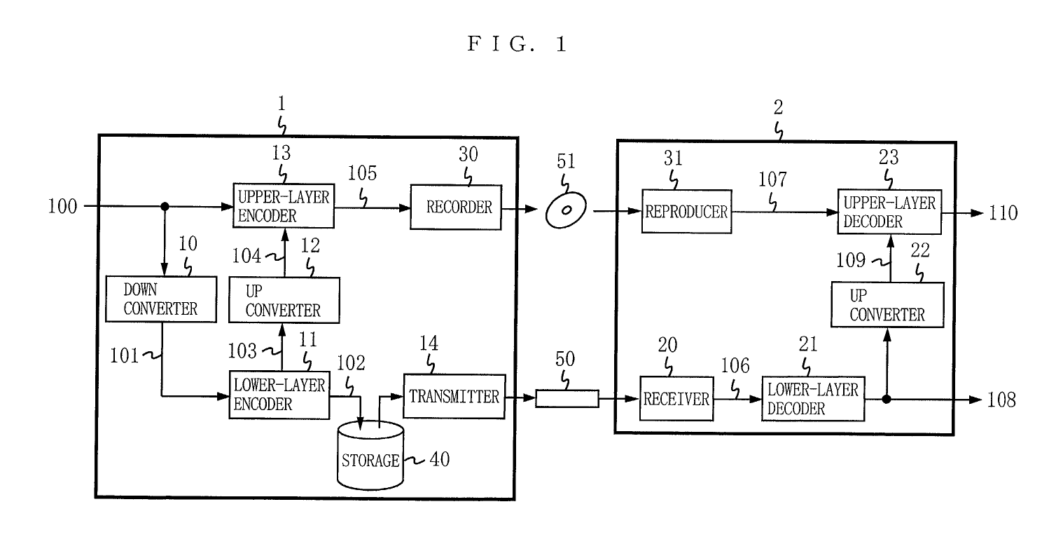

FIG. 1 is a block diagram showing the structure of a video signal transmission/reception system according to a first embodiment of the present invention. The system of FIG. 1 performs hierarchical encoding and includes a video signal encoder 1 and a video signal decoder 2. This system is characterized in that, between the video signal encoder 1 and the video signal decoder 2, an encoded bitstream in an upper layer is passed in a recording medium 51.

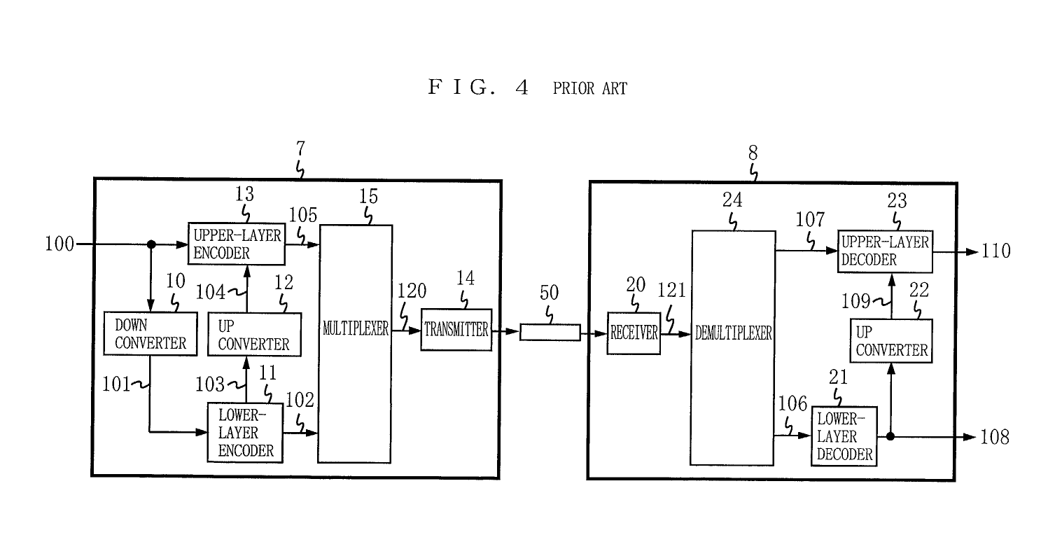

The video encoder 1 is provided with the down converter 10, the lower-layer encoder 11, the up converter 12, the upper-layer encoder 13, the transmitter 14, a recorder 30, and a storage 40. Among those, the down converter 10, the lower-layer encoder 11, the up converter 12, and the upper-layer encoder 13 carry out, specifically, the MPEG-2 encoding in the spatial scalability mode. Note here that, any constituent appeared in FIG. 4 is under the same reference numeral.

The down converter 10 carries out sampling-rate conversion in a predetermined manner with respect to the HSR video signal 100, and the resulting signal is a video signal 101 of low sampling rate (LSR video signal 101). Specifically, with respect to the HSR video signal 100, applying a down-sampling filter each in the horizontal and vertical directions of a frame will lead to the LSR video signal 101. To the LSR video signal 101, the lower-layer encoder 11 then performs lower-layer encoding as a part of MPEG-2 spatial-scalability encoding. Together with the resulting base layer bitstream 102, the lower-layer encoder 11 outputs a local decode out 103, which is a video signal obtained by decoding the base layer bitstream 102.

The local decode out 103 is then transferred to the up converter 12, and so converted as to be in the same sampling rate as the HSR video signal 100. A signal obtained thereby is an up-sampled video signal 104. Specifically, with respect to the local decode out 103, applying an up-sampling filter each in the horizontal and vertical directions of a frame will lead to the up-sampled video signal 104. With respect to the up-sampled video signal 104 and the HSR video signal 100, the upper-layer encoder 13 then performs upper-layer encoding as a part of MPEG-2 spatial-scalability encoding. Derived thereby is the enhancement layer bitstream 105.

The base layer bitstream 102 outputted from the lower-layer encoder 11 is stored in the storage 40, which is exemplified by a hard disk drive. On the other hand, the enhancement layer bitstream 105 outputted from the upper-layer encoder 13 is recorded on the recording medium 51 by the recorder 30. Here, the recording medium 51 is an arbitrary recording medium detachable to the video signal encoder 1, and exemplified by a tape, a disk, and the like. The enhancement layer bitstream 105 is recorded on the recording medium 51 on a broadcast program basis.

The recording medium 51 having the enhancement layer bitstream 105 recorded thereon is distributed over the distribution channels involving billing and access management. A user of the video signal decoder 2 may purchase the recording medium 51 in a shop or by mail-order, or download the enhancement layer bitstream 105 from any data server with a billing-management function. The recording medium 51 is distributed for pay or for free as a sample, and mounted to the video signal decoder 2.

After a lapse of time considered sufficient for the recording medium 51 to be available for the user, the video signal encoder 1 transmits the base layer bitstream 102 in the storage 40 to the video signal decoder 2. The base layer bitstream 102 is transmitted over a communications path 50, which is exemplarily a cable for CATV. For the transmission, terrestrial broadcasting and satellite broadcasting may also be utilized.

The video signal decoder 2 includes the receiver 20, the lower-layer decoder 21, the up converter 22, the upper-layer decoder 23, and a reproducer 31. Among those, the lower-layer encoder 21, the up converter 22, and the upper-layer decoder 23 also carry out the MPEG-2 encoding in the spatial scalability mode.

In the video decoder 2, the base layer bitstream 102 transferred from the video signal encoder 1 is received by the receiver 20, and outputted as the base layer bitstream 106. In synchronization therewith, the reproducer 31 reproduces from the recording medium 51 an enhancement layer bitstream 107, which corresponds to the base layer bitstream 106. For synchronization therebetween, the reproducer 31 refers to time stamps in those bitstreams.

The lower-layer encoder 21 then decodes the base layer bitstream 106 in an inverse manner to the encoding performed in the lower-layer encoder 11, and outputs the decoded LSR video signal 108. The decoded LSR video signal 108 is then subjected to the sampling-rate conversion in a predetermined manner by the up converter 22, and derived thereby is an up-sampled video signal 109. Specifically, with respect to the decoded LSR video signal 108, applying an up-sampling filter each in the horizontal and vertical directions of a frame will lead to the up-sampled video signal 109.

The upper-layer decoder 23 then decodes, in an inverse manner to the encoding performed in the upper-layer encoder 13, the up-sampled video signal 109 and the enhancement layer bitstream 107. After the decoding, derived is the decoded HSR video signal 110.

In the case that the enhancement layer bitstream 107 corresponding to the base layer bitstream 106 is not reproduced from the recording medium 51, the upper-layer decoder 23 cannot derive the decoded HSR video signal 110. If this is the case, the decoded LSR video signal 108 is only an output.

As such, in the video signal transmission/reception system of the present embodiment, the encoded bitstream in the upper layer is recorded on the removable-type recording medium. With the recording medium mounted, the video signal decoder outputs a video signal of high image quality based on both the upper-layer bitstream reproduced from the recording medium and the lower-layer bitstream. Without the recording medium mounted, outputted from the video signal decoder is a video signal of standard image quality based only on the lower-layer bitstream. Therefore, with the billing and access management on the recording medium in the course of distribution, the resulting video signal provided by the video signal decoder can be accordingly charged and accessed depending on its image quality.

(Second Embodiment)

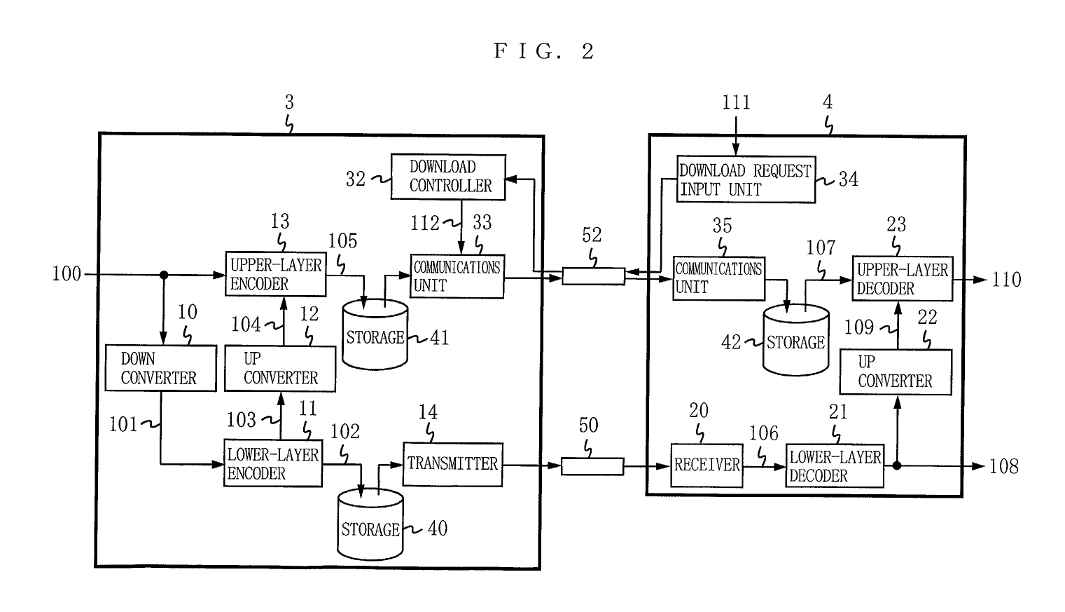

FIG. 2 is a block diagram showing the structure of a video signal transmission/reception of a second embodiment of the present invention. The system of FIG. 2 performs hierarchical encoding and includes a video signal encoder 3 and a video signal decoder 4. This system is characterized in that, between the video signal encoder 3 and the video signal decoder 4, an encoded bitstream in an upper layer is passed ver a communications path 52 with a higher priority than another in a lower layer.

The video signal encoder 3 is provided with the down converter 10, the lower-layer encoder 11, the up converter 12, the upper-layer encoder 13, the transmitter 14, a download controller 32, a communications unit 33, the storage 40, and a storage 41. On the other hand, the video signal decoder 4 is provided with the receiver 20, the lower-layer decoder 21, the up converter 22, the upper-layer decoder 23, a download request input unit 34, a communications unit 35, and a storage 42. Here, any constituent appeared in the system of the first embodiment is denoted by the same reference numeral, and not described again.

The video signal encoder 3 derives, as does the video signal encoder 1 of the first embodiment, the base layer bitstream 102 and the enhancement layer bitstream 105 based on the input HSR video signal 100. The base layer bitstream 102 is stored in the storage 40, while the enhancement layer bitstream 105 in the storage 41.

Based on the received base layer bitstream 106 and the enhancement layer bitstream 107 read from the storage 42, the video signal decoder 4 derives, as does the video signal decoder 2 of the first embodiment, the decoded LSR video signal 108 and the decoded HSR video signal 110.

Prior to receiving a certain broadcast program, the user of the video signal decoder 4 requests the video signal encoder 3 to download the enhancement layer bitstream 107 of the broadcast program. To make such request, the user operates the download request input unit 34, and inputs a command 111. The command is then transferred through the communications path 52 to the download controller 32, which is in the video signal decoder 4.

Once received the command 111, the download controller 32 goes through the billing and access management process to see whether accept the command 111. Here, downloading may be for pay or for free. Alternatively, the download controller 32 may receive the user's key code together with the command 111, and utilize those to go through the billing and access management process.

If determined to accept the command 111, the download controller 32 outputs a download instruction signal 112, and instructs the communications unit 33 to start downloading. The communications unit 33 responsively reads the enhancement layer bitstream 105 in the storage 41, and transmits it to the video signal decoder 4. The enhancement layer bitstream 105 is then stored in the storage 41 via the communications unit 35.

After a lapse of time considered sufficient for the storage 42 to store the base layer bitstream 105, the video signal encoder 3 transmits the base layer bitstream 102 in the storage 40 to the video signal decoder 4.

In the video decoder 4, the base layer bitstream 102 transferred from the video signal encoder 3 is received by the receiver 20, and outputted as the base layer bitstream 106. In synchronization therewith, the corresponding enhancement layer bitstream 107 is read from the storage 42. Then, based on the base layer bitstream 106 and the enhancement layer bitstream 107, derived are the decoded LSR video signal 108 and the decoded HSR video signal 110.

In the case that the enhancement layer bitstream 107 corresponding to the base layer bitstream 106 is not stored in the storage 42, the upper-layer decoder 23 cannot derive the decoded HSR video signal 110. If this is the case, the decoded LSR video signal 108 is only an output from the video signal decoder 4.

As such, in the video signal transmission/reception system of the present embodiment, the encoded upper-layer bitstream is transmitted over the communication path prior to the lower-layer bitstream, and stored in the video signal decoder. Then, based on thus stored upper-layer bitstream and the received lower-layer bitstream, the video signal decoder outputs a video signal of high image quality. Without the upper-layer bitstream in the storage, outputted from the video signal decoder is a video signal of standard image quality based only on the lower-layer bitstream. Therefore, with the billing and access management in the course of transmitting and receiving the upper-layer bitstream, the resulting video signal provided by the video signal decoder can be accordingly charged and accessed depending on its image quality.

Further, the video signal encoder once stores the lower-layer bitstream in the storage before transmitting the same. In this manner, the lower-layer bitstream can be transmitted responding to a transmission request coming from the video signal decoder with an arbitrary timing. Still further, before transmitting the upper-layer bitstream, the video signal encoder goes through the billing and access management process according to the transmission request coming from the video signal decoder. In this manner, the video signal encoder transmits the upper-layer bitstream only for the command-accepted video signal decoder.

(Third Embodiment)

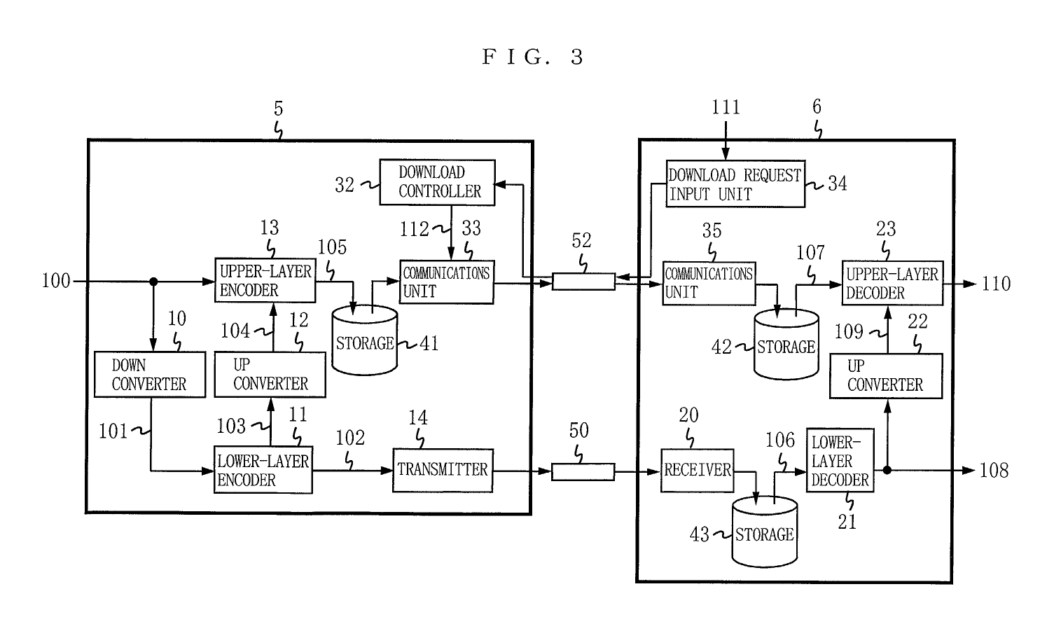

FIG. 3 is a block diagram showing the structure of a video signal transmission/reception system according to a third embodiment of the present invention. The system of FIG. 3 performs hierarchical encoding and includes a video signal encoder 5 and a video signal decoder 6. This system is characterized in that, between the video signal encoder 5 and the video signal decoder 6, an encoded bitstream in a lower layer is passed over the communications path 52 with a higher priority than another in an upper layer.

The video signal encoder 5 is provided with the down converter 10, the lower-layer encoder 11, the up converter 12, the upper-layer encoder 13, the transmitter 14, the download controller 32, the communications unit 33, and the storage 41. On the other hand, the video signal decoder 6 is provided with the receiver 20, the lower-layer decoder 21, the up converter 22, the upper-layer decoder 23, the download request input unit 34, the communications unit 35, the storage 42, and a storage 43. Here, any constituent appeared in the systems of the first and second embodiments is denoted by the same reference numeral, and not described again.

The video signal encoder 5 derives, as does the video signal encoder 1 of the first embodiment, the base layer bitstream 102 and the enhancement layer bitstream 105 based on the input HSR video signal 100. In this embodiment, the base layer bitstream 102 is transmitted by the transmitter 14 to the video signal decoder 6 without being stored. The enhancement layer bitstream 105 is stored in the storage 41.

In the video signal decoder 6, the base layer bitstream 102 is stored in the storage 43. The user of the video signal decoder accesses the video signal encoder 5 in the same manner as the second embodiment. Then, based on the base layer bitstream 106 read from the storage 43 and the enhancement layer bitstream 107 from the storage 42, derived are the decoded LSR video signal 108 and the decoded HSR video signal 110.

As such, in the video signal transmission/reception system of the present embodiment, an encoded bitstream in a lower layer is immediately transmitted to the video signal decoder for storage therein. During storing lower-layer bitstream, the video signal decoder receives the upper-layer bitstream over a separately-provided communications path. Based on both the lower-and upper-layer bitstreams, the video signal decoder outputs a video signal of high image quality. On the other hand, without storing the upper-layer bitstream, the video signal decoder outputs a video signal of standard image quality based only on the lower-layer bitstream. Therefore, similar to the second embodiment, with the billing and access management in the course of transmitting and receiving the upper-layer bitstream, the resulting video signal provided by the video signal decoder can be accordingly charged and accessed depending on its image quality.

Further, in the third embodiment, the lower-layer bitstream is stored in the video signal decoder. Therefore, after a broadcast program is transmitted, the video signal decoder receives the encoded upper-layer bitstream, and then outputs a video signal of high image quality.

In the first to third embodiments, the video signal is subjected to hierarchical encoding in two levels. This is not restrictive, and the hierarchical encoding may be carried out in three or more levels. If this is the case, after the hierarchical encoding, the resulting three or more encoded bitstreams are classified into the upper and lower layers, and only the bitstream classified in the upper layer is passed in a recording medium or by any separately-provided communications means. If the bitstream classified in the upper layer is plural, those are recorded on each different recording medium for billing and access management under different schemes.

Further, in the above described hierarchical encoding, the video signal is sampled in the spatial direction. This is not surely restrictive, and the video signal may be sampled in the time direction, or both in the spatial and time directions. Still further, in the video signal encoder 3 in the second embodiment and the video signal decoder 6 in the third embodiment, there are two storages provided for each storing the encoded bitstream. Here, one storage will do for two encoded bitstreams.

Still further, the video signal encoders and decoders of the first to third embodiments may be implemented by a combination of a computer and a program runnable thereon.

While the invention has been described in detail, the foregoing description is in all aspects illustrative and not restrictive. It is understood that numerous other modifications and variations can be devised without departing from the scope of the invention.

What is claimed is:

1. A video signal encoder for encoding and transmitting a video signal, comprising:
a hierarchical encoding unit for generating a second video signal of relatively lower-resolution from an inputted first video signal of relatively higher-resolution, deriving a lower-layer bitstream by encoding said second video signal, and deriving an upper-layer bitstream by encoding said first video signal utilizing a decoding result of said lower-layer bitstream;
a transmission unit for transmitting said lower-layer bitstream; and
a bitstream output unit for outputting said upper-layer bitstream separately from said transmission unit.

2. The video signal encoder according to claim 1, wherein said bitstream output unit records said upper-layer bitstream in a removable recording medium.

3. The video signal encoder according to claim 1, wherein said bitstream output unit transmits said upper-layer bitstream by communications means separately from said transmission unit.

4. The video signal encoder according to claim 3, wherein said bitstream output unit stores said upper-layer bitstream, and transmits the upper-layer bitstream according to an inputted transmission request.

5. The video signal encoder according to claim 4, wherein said bitstream output unit performs a billing process according to said transmission request.

6. The video signal encoder according to claim 1, wherein said transmission unit stores said lower-layer bitstream, and transmits the lower-layer bitstream after a predetermined lapse of time.

7. The video signal encoder according to claim 1, wherein said hierarchical encoding unit includes:
a first format conversion unit for converting said first video signal in resolution to derive said second video signal;
a lower layer encoding unit for deriving said lower-layer bitstream and the decoding result of said lower-layer bitstream by encoding said second video signal;
a second format conversion unit for converting said decoding result into a video signal in the same format as said first video signal; and
an upper layer encoding unit for deriving said upper-layer bitstream by encoding said first video signal utilizing the video signal derived by said second format conversion unit.

8. A video signal decoder for receiving and decoding an encoded video signal, comprising:
a reception unit for receiving a lower-layer bitstream among other bitstreams derived by hierarchically-encoding the video signal;
a bitstream supply unit for supplying an upper-layer bitstream among said other bitstreams separately from said reception unit; and
a hierarchical decoding unit for deriving a first video signal of relatively lower-resolution by decoding said lower-layer bitstream received by said reception unit, and deriving a second video signal of relatively higher-resolution by decoding said upper-layer bitstream utilizing said first video signal.

9. The video signal decoder according to claim 8, wherein said reception unit and said bitstream supply unit supply, to said hierarchical decoding unit, said lower-layer bitstream and said upper-layer bitstream with synchronization established therebetween.

10. The video signal decoder according to claim 8, wherein said bitstream supply unit reproduces said upper-layer bitstream from a removable recording medium, and supplies the upper-layer bitstream to said hierarchical decoding unit.

11. The video signal decoder according to claim 8, wherein said bitstream supply unit receives said upper-layer bitstream by communications means separately from said reception unit, and stores first and then transmits said upper-layer bitstream to said hierarchical decoding unit.

12. The video signal decoder according to claim 11, wherein said bitstream supply unit outputs a transmission request for said upper-layer bitstream in response to an inputted transmission instruction.

13. The video signal decoder according to claim 8, wherein said reception unit first stores said lower-layer bitstream, and then supplies the lower-layer bitstream to said hierarchical decoding unit.

14. The video signal decoder according to claim 8, wherein said hierarchical decoding unit includes:
a lower-layer decoding unit for deriving said first video signal by decoding said lower-layer bitstream;
a format conversion unit for converting said first video signal into a video signal in the same format as said second video signal; and
an upper-layer decoding unit for deriving said second video signal by decoding said upper-layer bitstream utilizing the video signal derived by said format conversion unit.

15. A video signal encoding method for encoding and transmitting a video signal, comprising the steps of:
generating a second video signal of relatively lower-resolution from an inputted first video signal of relatively higher-resolution, deriving a lower-layer bitstream by encoding said second video signal, and deriving an upper-layer bitstream by encoding said first video signal utilizing a decoding result of said lower-layer bitstream;
transmitting said lower-layer bitstream; and
outputting said upper-layer bitstream separately from said transmitting step.

16. A video signal decoding method for receiving and decoding an encoded video signal, comprising the steps of:
receiving a lower-layer bitstream among other bitstreams derived by hierarchically-encoding the video signal;
supplying an upper-layer bitstream among said other bitstreams separately from said receiving step; and
deriving a first video signal of relatively lower-resolution by decoding said lower-layer bitstream received in said receiving step, and deriving a second video signal of relatively higher-resolution by decoding said upper-layer bitstream supplied in said supplying step utilizing said first video signal.

17. A computer-readable recording medium on which a program to be run on a computer is recorded for executing a video signal encoding method for encoding and transmitting a video signal, said program comprising the steps of:
generating a second video signal of relatively lower-resolution from an inputted first video signal of relatively higher-resolution, deriving a lower-layer bitstream by encoding said second video signal, and deriving an upper-layer bitstream by encoding said first video signal utilizing a decoding result of said lower-layer bitstream;
transmitting said lower-layer bitstream; and
outputting said upper-layer bitstream separately from said transmitting step.

18. A computer-readable recording medium on which a program to be run on a computer is recorded for executing a video signal decoding method for receiving and decoding an encoded video signal, said program comprising the steps of:
receiving a lower-layer bitstream among other bitstreams derived by hierarchically-encoding the video signal;
supplying an upper-layer bitstream among said other bitstreams separately from said receiving step; and
deriving a first video signal of relatively lower-resolution by decoding said lower-layer bitstream received in said receiving step, and deriving a second video signal of relatively higher-resolution by decoding said upper-layer bitstream supplied in said supplying step utilizing said first video signal.
